(19) United States
(12) Patent Application Publication
(10) Pub. No.: US 2013/0205289 A1
(43) Pub. Date: Aug. 8, 2013

(54) UPDATE CONTROLLING METHOD FOR FIRMWARE, BASE STATION APPARATUS AND COMMUNICATION SYSTEM

(71) Applicant: FUJITSU LIMITED, Kawasaki-shi (JP)

(72) Inventor: Masataka UNNO, Yokohama (JP)

(73) Assignee: FUJITSU LIMITED, Kawasaki-shi (JP)

(21) Appl. No.: 13/756,996

(22) Filed: Feb. 1, 2013

(30) Foreign Application Priority Data
Feb. 8, 2012 (JP) 2012-024928

(51) Int. Cl. G06F 9/445

(52) U.S. Cl. CPC G06F 8/65
USPC 717/171

(57) ABSTRACT

A method comprises selecting from among a plurality of firmware updating procedures, a firmware updating procedure by which a service stopping period that arises, in at least one of communication schemes, from firmware updating in at least one of a common function section and a plurality of individual function sections, the service stopping period being equal to or lower than a predetermined threshold value, and carrying out the selected firmware updating procedure.

### CROSS-REFERENCE TO RELATED APPLICATIONS

This application is based upon and claims the benefit of priority of the prior Japanese Patent Application No. 2012-024928, filed on Feb. 8, 2012, the entire contents of which are incorporated herein by reference.

### FIELD

The present invention relates to an updating controlling method for firmware, abase station apparatus and a communication system. The base station apparatus includes, for example, a base station apparatus capable of being ready for a plurality of communication schemes.

### BACKGROUND

In the field of mobile communication in recent years, various services including not only voice communication but also access to the internet, distribution of streaming broadcasting, distribution of content such as music, video and so forth are developed. Further, in order to provide the services in high quality, increase of the speed of communication, expansion of wireless communication areas and so forth are demanded.

Therefore, LTE (Long Term Evolution), which is a developed type of 3G (3rd Generation) such as W-CDMA (Wideband-Code Division Multiple Access) or the like, has been standardized and is utilized.

An example of configuration of a communication system 100 in which a plurality of communication schemes including 3G and LTE are included is illustrated in FIG. 1.

The communication system 100 illustrated in FIG. 1 includes, for example, user apparatuses (UE; User Equipment) 200-1 and 200-2, a BTS (Base Transceiver Station) 300, an RNC (Radio Network Controller) 400 and an eNB (eNodeB) 300. Further, the communication system 100 is connected, for example, to a core network 600.

In the communication system 100, the UE 200-1, BTS 300 that communicates with the UE 200-1 and RNC 400 that controls the BTS 300 configure a 3 G communication system together with an SGSN (Serving GPRS Support Node), a GGSN (Gateway GPRS Support Node) and an HLR (Home Location Register) that are positioned on the core network 600 side.

It is to be noted that the SGSN is an apparatus that controls information such as protocol information, an IP address and so forth while the GGSN is an apparatus that connects to an external network, and the HLR is an apparatus that manages user information such as a terminal identification number.

Further, in the communication system 100, the UE 200-2 and the eNB 500 that communicates with the UE 200-2 configure an LTE communication system together with an SGW (Serving GateWay), a PGW (Packetdatanetwork GateWay), an MME (Mobility Management Entity) and an HSS (Home Subscriber Server) that are positioned on the core network 600 side.

It is to be noted that the SGW is an apparatus that repeats user data while the PGW is an apparatus that connects to an external network. Further, the MME is an apparatus that manages position registration, calling, handover and so forth of the UE 200-2 while the HSS is an apparatus that manages user information such as a terminal identification number.

Furthermore, a network management apparatus that maintains and manages the communication system 100 and a like apparatus may be disposed on the core network 600 side.

Further, the communication system 100 may include, for example, a communication system for use with a road traffic information communication system, an optical communication system such as FTTH (Fiber To The Home) and other communication systems.

It is to be noted that Japanese Laid-Open Patent Publication No. 2011-171863 (hereinafter referred to as Patent Document 1) proposes an antenna changeover method for a communication terminal that can be used commonly for two communication schemes different from each other.

Meanwhile, Japanese Laid-Open Patent Publication No. 2010-186226 (hereinafter referred to as Patent Document 2) proposes a method wherein, in a communication apparatus having a common controller and a plurality of individual controllers, version up of firmware is carried out without interrupting a monitoring process.

### SUMMARY

In recent years, a base station apparatus capable of being ready for a plurality of communication schemes by change of software or by like means has begun to be used.

In such a base station apparatus as just described, for example, a CPRI (Common Public Radio Interface) is sometimes applied as standards for a baseband signal processing function and a wireless processing function. The CPRI are standards that define communication between a wireless processing section (RE: Radio Equipment) that carries out a wireless signal process and a controller (REC: Radio Equipment Controller).

Here, a base station apparatus such as the BTS 300 or the eNB 500 is sometimes configured from an RE 700 and an REC 800 as illustrated in FIG. 2.

An example of a configuration of the REC 800 is illustrated in FIG. 3.

As illustrated in FIG. 3, the REC 800 includes a CPRI interface section 801 that provides an interface function with the RE 700, baseband processing sections 802-1 to 802-5 that process a baseband signal, a common function processing section 803 that function commonly to the entire REC 800, and a core network side interface section 804 that provides an interface function with the core network 600 side such as a high order apparatus. It is to be noted that the number of the baseband processing sections 802-1 to 802-5 is not limited to that of the example illustrated in FIG. 3.

If such an REC 800 as illustrated in FIG. 3 is applied, then a shared REC 800 ready for a plurality of communication schemes can be configured by causing the baseband processing sections 802-1 to 802-5 to carry out baseband signal processes of communication processes different from each other.

For example, the shared REC 800 can operate such that, while a 3G baseband signal is processed by the baseband processing sections 802-1 to 802-3, an LIE baseband signal is processed by the baseband processing sections 802-4 to 802-5.

While the processing sections 802-1 to 802-5 and 803 and the interface sections 801 and 804 are controlled by firmware, where new version firmware is provided, updating of the firmware is sometimes carried out.

Since, upon updating of the firmware, some reset process (restarting process) is carried out in the processing sections 802-1 to 802-5 and 803 and the interface sections 801 and 804, a period within which the service by the REC 800 is stopped arises.

However, Patent Documents 1 and 2 mentioned hereinabove do not clearly disclose in what manner firmware is updated in the REC 800 nor provide a method for reducing the service stopping period.

According to an aspect of the embodiments, an update controlling method for firmware in a communication apparatus including a plurality of individual function sections that function uniquely to a plurality of communication schemes respectively and a common function section that functions commonly to the communication schemes, comprising selecting, from among a plurality of firmware updating procedures, a firmware updating procedure by which a service stopping period that arises, in at least one of the communication schemes, from firmware updating in at least one of the common function section and the individual function sections, is equal to or lower than a predetermined threshold value, and carrying out the selected firmware updating procedure can be used.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a block diagram showing an example of a configuration of a communication system;

FIG. 2 is a block diagram showing an example of a configuration of a base station apparatus;

FIG. 3 is a view showing an example of a configuration of an REC;

FIG. 4 is a bock diagram showing an example of a configuration of a communication system according to an embodiment of the present invention;

FIGS. 5 to 9 are flowcharts illustrating an example of firmware updating control;

FIG. 10 is a flow chart illustrating an example of firmware updating control according to a first modification;

FIG. 11 is a flow chart illustrating an example of firmware updating control according to a second modification;

FIG. 12 is a view illustrating an example of setting of priorities;

FIGS. 13 and 14 are flow charts illustrating an example of firmware updating control according to a third modification; and

FIG. 15 is a block diagram showing an example of a hardware configuration of the base station apparatus.

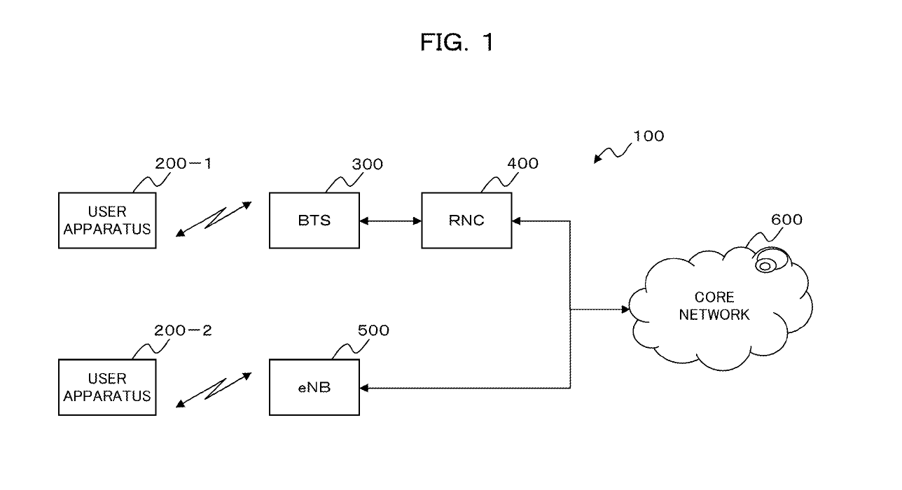

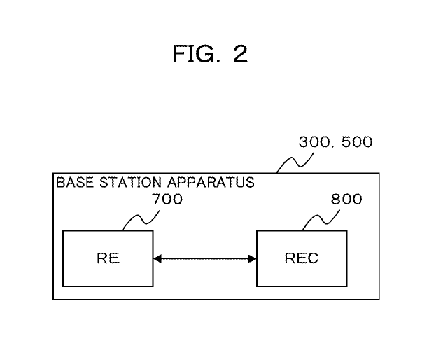

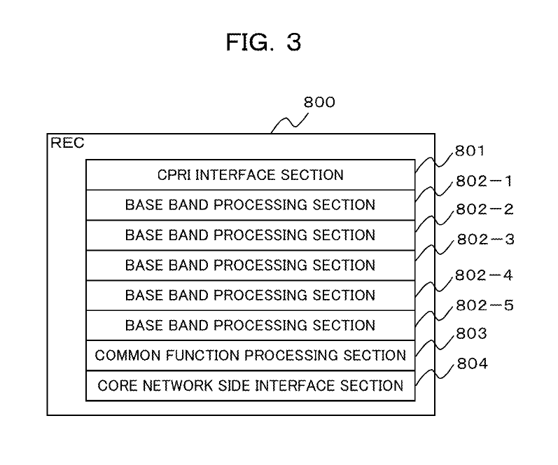

### DESCRIPTION OF THE PREFERRED EMBODIMENT

In the following, an embodiment of the present invention is described with reference to the drawings. However, the embodiment described below is illustrative to the end, and there is no intention to eliminate various modifications and applications of the technique not specified in the embodiment and modifications hereinafter described. In particular, variations and modifications can be made to the embodiment and the modifications described below without departing from the subject matter of the present invention.

### [1] Embodiment

(1.1) Example of the Configuration of the Communication System

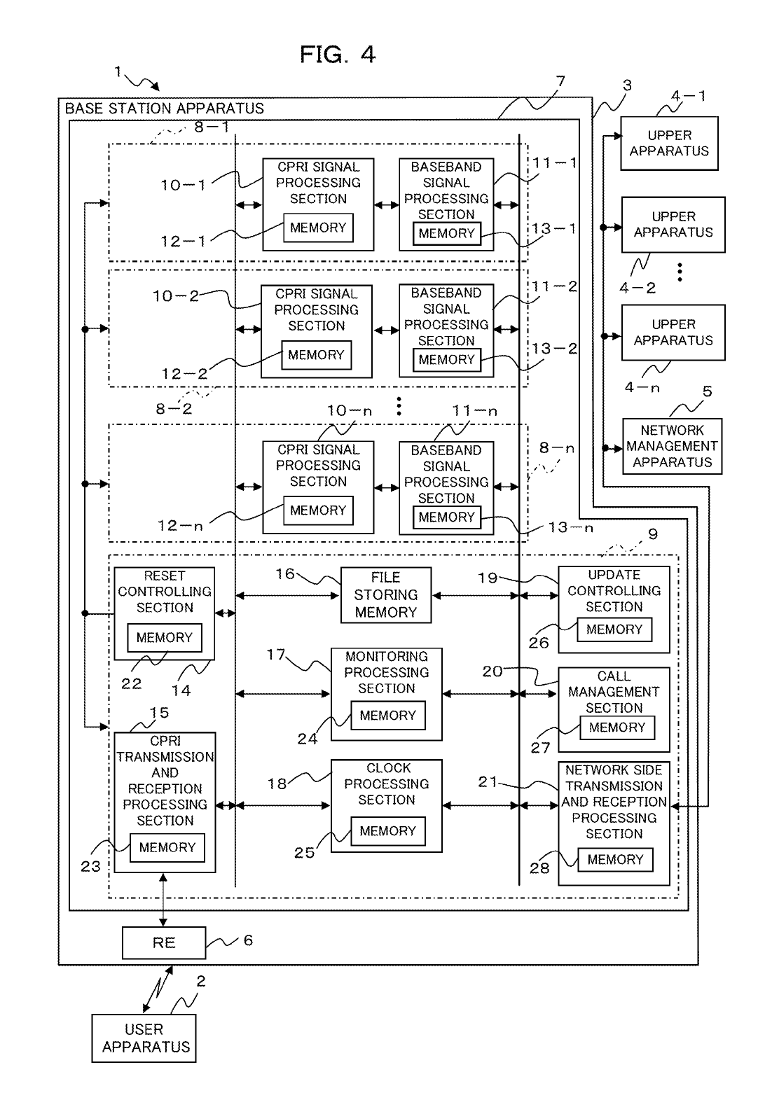

An example of a configuration of a communication system 1 according to an embodiment of the present disclosure is illustrated in FIG. 4.

As illustrated in FIG. 4, the communication system 1 includes a user apparatus (UE) 2 and abase station apparatus 3 capable of wirelessly communicating with the UE 2.

Further, the communication system 1 is connected to high order apparatuses 4-1, 4-2, . . . and 4-n (n is an integer equal to or greater than 2) for providing functions ready for a plurality of communication schemes different from each other and a network management apparatus 5 for maintaining and managing the communication system 1. It is to be noted that, where the high order apparatuses 4-1, 4-2, . . . and 4-n are not distinguished from each other in the following description, each of the high order apparatuses 4-1, 4-2, . . . and 4-n is referred to simply as high order apparatus 4.

Here, the base station apparatus 3 includes an RE 6 that provides a wireless communication function with the UE 2, and an REC 7 that controls the base station apparatus 3.

As illustrated in FIG. 4, the REC 7 includes individual function blocks (individual function sections) 8-1, 8-2, . . . and 8-n that correspond to the high order apparatus 4-1 to 4-n, respectively, and function uniquely to the communication schemes, and a common function block (common function section) 9 that functions commonly to the communication schemes. It is to be noted that, as illustrated in FIG. 4, the common function block 9 may include, for example, an interface function with the RE 6, high order apparatus 4 and network management apparatus 5.

In particular, the REC 7 is configured as a common REC having totaling (n+1) function blocks. It is to be noted that, where the individual function blocks 8-1, 8-2, . . . and 8-n are not distinguished from each other in the following description, each of the individual function blocks 8-1, 8-2, . . . and 8-n is referred to simply as individual function block 8.

Further, as illustrated in FIG. 4, each of the individual function blocks 8 and the common function block 9 are connected to each other by a data transmission path such as a bus so that data can be transferred between each other.

Here, the individual function blocks 8-1, 8-2, . . . and 8-n include CPRI signal processing sections 10-1, 10-2, . . . and 10-n that process, for example, a CPRI signal transferred to and from the RE 6, and baseband signal processing sections 11-1, 11-2, . . . and 11-n that process a baseband signal. It is to be noted that, where the CPRI signal processing sections 10-1, 10-2, . . . and 10-n are not distinguished from each other in the following description, each of the CPRI signal processing sections 10-1, 10-2, . . . and 10-n is referred to simply as CPRI signal processing section 10. Further, where the baseband signal processing sections 11-1, 11-2, . . . and 11-n are not distinguished from each other in the following description, each of the baseband signal processing sections 11-1, 11-2, . . . and 11-n is referred to simply as baseband signal processing section 11.

The CPRI signal processing sections 10-1, 10-2, . . . and 10-n include memories 12-1, 12-2, . . . and 12-n, respectively, and provide a CPRI signal processing function based on firmware in the memories 12-1, 12-2, . . . and 12-n.

Further, the baseband signal processing sections 11-1, 11-2, . . . and 11-n include memories 13-1, 13-2, . . . and 13-n, respectively, and provide a baseband signal processing function based on firmware in the memories 13-1, 13-2, . . . and 13-n. It is to be noted that, where the memories 12-1, 12-2, . . . and 12-n are not distinguished from each other in the following description, each of the memories 12-1, 12-2, . . . and 12-n is referred to simply as memory 12. Further, where the memories 13-1, 13-2, . . . and 13-n are not distinguished from each other in the following description, each of the memories 13-1, 13-2, . . . and 13-n is referred to simply as memory 13.

On the other hand, the common function block 9 includes, for example, a reset controlling section 14, a CPRI signal transmission and reception processing section 15, a file storing memory 16, a monitoring processing section 17, a clock processing section 18, an update controlling section 19, a call management section 20 and a network side transmission and reception processing section 21.

The reset controlling section 14 resets and restarts the individual function block 8 and the common function block 9 in response to an instruction from the update controlling section 19, the monitoring processing section 17 or the like. It is to be noted that the reset controlling section 14 can reset the individual function blocks 8-1, 8-2, . . . and 8-n and the common function block 9 all together (hereinafter referred to sometime as entire reset) and individually reset the function blocks (hereinafter referred to sometime as individual reset).

The CPRI signal transmission and reception processing section 15 transmits and receives a CPRI signal to and from the RE 6. Further, the CPRI signal transmission and reception processing section 15 can transmit, for example, a CPRI signal received from the RE 6 to the CPRI signal processing section 10 in each individual function block 8 and transmits a CPRI signal received from the CPRI signal processing section 10 to the RE 6.

The file storing memory 16 stores firmware for controlling the function sections 10, 11, 14, 15 and 17 to 21. For example, the firmware may be stored into the file storing memory 16 by the network management apparatus 5 or may be downloaded from an external network or the like and stored into the file storing memory 16. Or, the firmware may be directly transferred from an external storage apparatus or the like to the base station apparatus 3 and stored into the file storing memory 16.

The monitoring processing section 17 monitors an operation state of the individual function blocks 8 and the common function block 9. For example, if it is decided that state abnormality occurs in some of the individual function blocks 8 and the common function block 9, then the monitoring processing section 17 can transmit an alarm signal indicating occurrence of the state abnormality to the network management apparatus 5 and can transmit a control signal for resetting the block that exhibits the state abnormality to the reset controlling section 14.

The clock processing section 18 produces and outputs a clock signal to be used for processes in the individual function blocks 8 and common function block 9.

The update controlling section 19 controls an updating process of the firmware used in the REC 7. For example, the update controlling section 19 can select an update controlling method of the firmware and transmits a controlling signal in accordance with a result of the selection to the reset controlling section 14 so that the stopping period of the service provided by the base station apparatus 3 is reduced.

The call management section 20 manages calls which the base station apparatus 3 accommodates. For example, the call management section 20 can determine connection or disconnection of the calls and can collect information relating to the calls. For example, the call management section 20 can calculate a ratio of calls accommodated at present to the total number of calls that can be accommodated in the base station apparatus 3 and issue a notification of a result of the calculation to the update controlling section 19.

The network side transmission and reception processing section 21 transmits user data, a control signal and so forth to the high order apparatus 4 and the network management apparatus 5 and receives user data, a controlling signal and so forth from the network side of the high order apparatus 4, the network management apparatus 5 and so forth. Further, the network side transmission and reception processing section 21 can transmit, for example, user data, a control signal and so forth received from the network side to the individual function blocks 8 and transmit the user data, control signal and so forth received from the individual function blocks 8 to the network side.

Similarly to the CPRI signal processing section 10 and the baseband signal processing section 11 in the individual function blocks 8, also the function sections 14, 15 and 17 to 21 in the common function block 9 include memories 22 to 28, respectively, and provide functions based on the firmware in the memories 22 to 28.

Here, the firmware in the memories 12, 13 and 22 to 28 is updated by new firmware that is stored into the file storing memory 16, for example, taking reception of a reset command from the network management apparatus 5 as an opportunity.

While reset and restarting of the individual function blocks 8 and the common function block 9 are involved in the updating of the firmware, service stopping periods of the communication schemes provided by the base station apparatus 3 vary depending upon in what order the reset and restarting are carried out. The service stopping period is period during which a service using one of the communication schemes is not provided upon updating firmware in at least one of the common function block 9 and the individual function blocks 8.

(1.2) Firmware Updating Operation

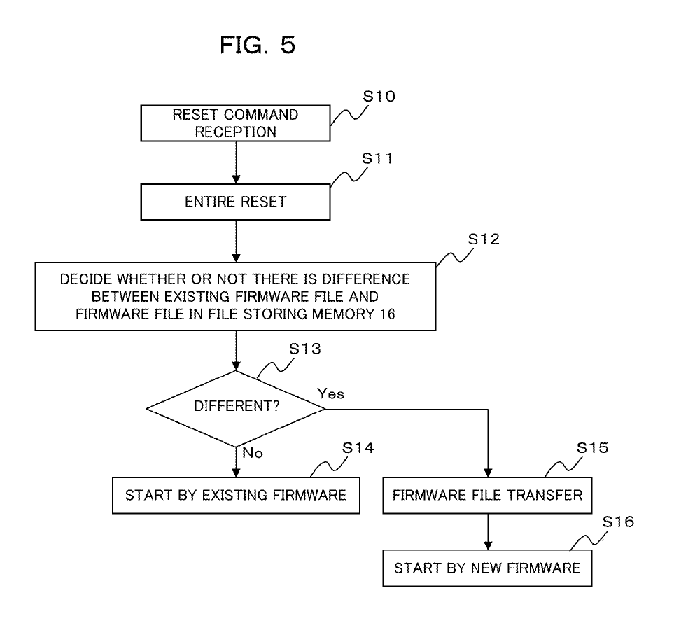

Here, an example of firmware updating operation is illustrated in FIG. 5.

As illustrated in FIG. 5, if a reset command is received from the network management apparatus 5 or the like first (step S10), then the base station apparatus 3 resets and restarts all of the individual function blocks 8 and common function block 9 all together (step S11).

Then, the base station apparatus 3 decides whether or not there is a difference between the firmware used at present and the firmware in the file storing memory (step S12). Confirmation of the difference may be carried out by comparing the version number of the firmware used at present and the version number of the firmware in the file storing memory 16 with each other.

Here, the function sections 10, 11, 14, 15 and 17 to 21 that use the firmware decided that there is no difference (No route at step S13) provide the functions as they are using the firmware at present (step S14).

On the other hand, the function sections 10, 11, 14, 15 and 17 to 21 that use the firmware decided that there is a difference (Yes route at step S13) transfer new firmware from the file storing memory 16 to the memories 12, 13 and 22 to 28 (step S15), and provide the functions using the new firmware after the reset and restarting (step S16).

Here, when the updating process by the new firmware is completed and the functions are started at step S16, overall resetting of the individual function blocks 8-1, 8-2, . . . and 8-n and the common function block 9 or individual resetting of a function block or blocks that use the new firmware from among the individual function blocks 8-1, 8-2, . . . and 8-n and the common function block 9 is involved in the process at step S16 after completion of the transfer of the new firmware.

In particular, when updating of the firmware is carried out, the base station apparatus 3 starts the function block using the firmware at present (old firmware before updating), for example, after overall resetting in accordance with the reset command is carried out. Then, the version number of the firmware stored in the file storing memory 16 is confirmed, and, if the version number of the firmware stored in the file storing memory 16 is different from that of the firmware at present, then the new firmware is transferred from the file storing memory 16 to the memories 12, 13 and 22 to 28. Further, after completion of the transfer of the new firmware, overall resetting or individual resetting is carried out and service provision by the new firmware is started.

In this manner, where a device for which a configuration or a boot process is required upon updating of firmware or the like is used, such a base station apparatus 3 that is not ready for online updating, which is commonly difficult to deal with, carries out a firmware updating process including individual resetting or overall resetting.

At this time, for an apparatus that is commonly used in a plurality of communication schemes such as the base station apparatus 3, there is a demand to minimize the service stopping time period by setting a startup time period of a function section relating to one communication scheme so as not to be influenced by a startup time period of any other function section relating to another communication scheme.

Therefore, in the present embodiment, firmware update control capable of reducing the startup time period or the service stopping time period of the base station apparatus 3 as far as possible is carried out.

(2.1) Example of the Firmware Update Controlling Method According to the Embodiment

Here, an example of the firmware update controlling method according to the embodiment is described.

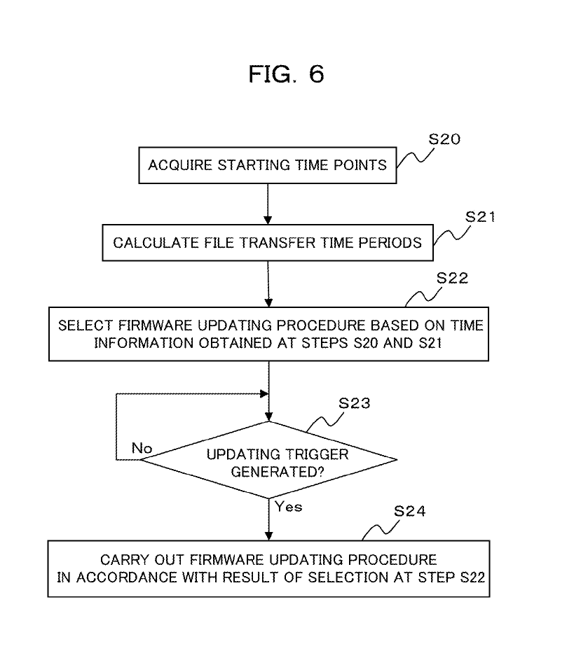

As illustrated in FIG. 6, the update controlling section 19 first acquires a startup time period (starting time period) by the firmware at present and another startup time period (starting time period) by new firmware for each of the function blocks 8 and 9 (step S20). It is to be noted here that the startup time period (starting time period) signifies a time period required from carrying out the resetting process to restarting to provide the service.

In particular, for example, by the network management apparatus 5 or the like, time required for starting of the function sections 10, 11, 14, 15 and 17 to 21 using the present firmware and time required for starting of the function sections 10, 11, 14, 15 and 17 to 21 using the new firmware are measured in advance by a simulation or the like, and a result of the measurement is stored into the memory 26 in the update controlling section 19. Consequently, the update controlling section 19 can acquire the information relating to the starting time periods from the memory 26.

Further, the information relating to the starting time periods may be written into the header of a control signal to the base station apparatus 3 or the firmware. In this instance, the update controlling section 19 can acquire the information relating to the starting time periods by referring to the header of the control signal to the base station apparatus 3 or the header of the firmware.

Then, the update controlling section 19 determines a maximum value of the starting time period by the present firmware relating to the function sections 10 and 11 in the individual function blocks 8 as a starting time period by the present firmware in the individual function blocks 8.

Similarly, the update controlling section 19 determines a maximum value of the starting time period by the new firmware relating to the function sections 10 and 11 in the individual function blocks 8 as a starting time period by the new firmware in the individual function blocks 8.

Further, the update controlling section 19 determines a maximum value of the starting time period by the present firmware relating to the function sections 14, 15 and 17 to 21 in the common function block 9 as a starting time period by the present firmware in the common function block 9.

Similarly, the update controlling section 19 determines a maximum value of the starting time period by the new firmware relating to the function sections 14, and 17 to 21 in the common function block 9 as a starting time period by the new firmware in the common function block 9.

Then, the update controlling section 19 acquires a time period (file transfer time period) required to transfer the new firmware from the file storing memory 16 to the memories 12, 13 and 22 to 28 for each of the function blocks 8 and 9 (step S21).

In particular, the update controlling section calculates (predicts) a time period required for transfer of the new firmware by the function sections 10, 11, 14, 15 and 17 to 21 from the file storing memory 16 to the memories 12, 13 and 22 to 28, respectively, based on a file transfer speed in the data transmission path in the base station apparatus 3 and the file size of the new firmware.

It is to be noted that a notification of the file transfer speed in the data transmission path in the base station apparatus 3 and the file sizes of the new firmware may be issued to the update controlling section 19 in advance, for example, by the network management apparatus 5, or the update controlling section 19 may acquire the information in advance.

Also a process regarding a file transfer time period may be carried out similarly to that for the information relating to the starting time periods described above such that the file transfer time is calculated in advance by a simulation and a result of the calculation is stored into the memory 21 and then the update controlling section 19 refers to the memory 26 to acquire the file transfer time. Further, the result of the calculation is written into the header of a control signal to the base station apparatus 3 or the header of the firmware, and the update controlling section 19 refers to the header of the control signal or the firmware to acquire the file transfer time.

Then, the update controlling section 19 determines a maximum value of a file transfer time period relating to the function sections 10 and 11 in the individual function blocks 8 as a file transfer time period in the individual function blocks 8.

For example, where the file size of the firmware for the CPRI signal processing section 10 is 1 “Mbytes” and the file transfer speed is 1 “Mbytes/min”, the file transfer time period regarding the CPRI signal processing section 10 is 1 [min]. Further, for example, where the file size of the firmware for the baseband signal processing section 11 is 2.4 “Mbytes” and the file transfer speed is 0.4 “Mbytes/min”, the file transfer time period regarding the baseband signal processing section 11 is [min].

In this instance, the file transfer time period of the individual function blocks 8 including the CPRI signal processing section 10 and the baseband signal processing section 11 is determined as 6 [min].

Similarly, the update controlling section 19 determines a maximum value of the file transfer time period relating to the function sections 14, 15 and 17 to 21 in the common function block 9 as a file transfer time period in the common function block 9.

The processes at steps S20 and S21 may be carried out by at least once after completion of starting of the base station apparatus 3 (particularly, after a point of time at which provision of the service by each communication scheme can be started). It is to be noted that it is preferable to carry out the processes at steps S20 and S21 described above every time the firmware in the file storing memory 16 is updated.

Then, the update controlling section 19 selects an updating method for the firmware based on the time information acquired at steps S20 and S21 (step S22).

Here, the updating method for the firmware includes, for example, a method that involves overall resetting after completion of starting of the new firmware (hereinafter referred to sometimes as updating procedure #1 or first firmware updating procedure) and another method that involves individual resetting after completion of starting of the new firmware (hereinafter referred to sometime as updating procedure #2 or second firmware updating procedure).

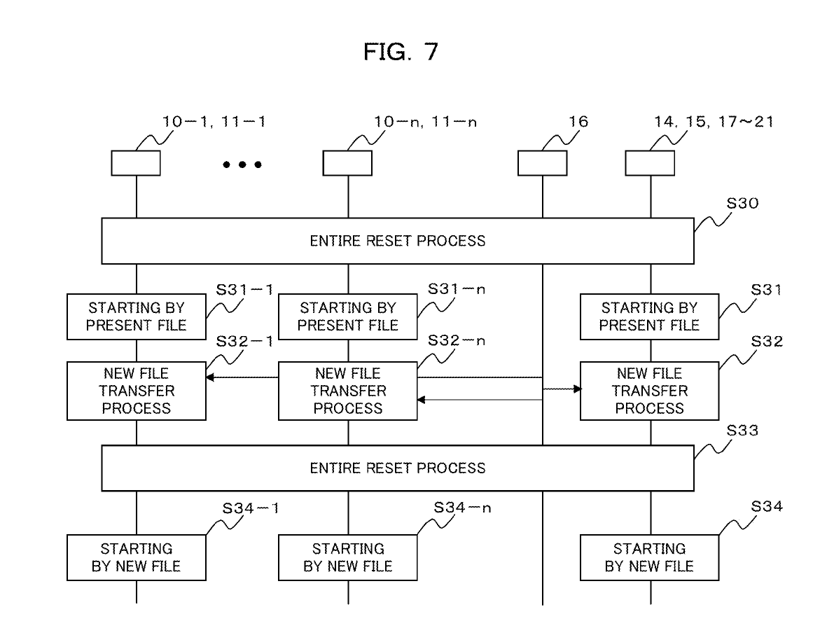

For example, as illustrated also in FIG. 7, the updating procedure #1 is carried out in accordance with procedures 1-1 to 1-8 described below.

Procedure 1-1: If a firmware updating opportunity by a reset command or the like from the network management apparatus 5 arises, then the reset controlling section 14 carries out system resetting (overall resetting process) (step S30).

Procedure 1-2: The function sections 10, 11, 14, 15 and 17 to 21 are started by the present firmware (steps S31-1, . . . , S31-n and S31).

Procedure 1-3: The function sections 10, 11, 14, and 17 to 21 confirm a difference between the version number of the firmware stored in the file storing memory 16 and the version number of the present firmware.

Procedure 1-4: If it is confirmed in the procedure 1-3 that there is a version number difference, then the function sections 10, 11, 14, 15 and 17 to 21 request transfer of the new firmware from the file storing memory 16 to the memories 12, 13 and 22 to 28 in the function sections 10, 11, 14, 15 and 17 to 21 to the monitoring processing section 17.

Procedure 1-5: If the transfer request is received from any of the function sections 10, 11, 14, 15 and 17 to 21, then the monitoring processing section 17 starts transfer of the new firmware (steps S32-1, . . . , S32-n and S32) and requests preparation for system resetting (overall resetting) to the reset controlling section 14. It is to be noted that, while, in the example illustrated in FIG. 7, all of the function sections 10, 11, 14, 15 and 17 to 21 transfer the new firmware, this is an example to the end and, actually the function sections 10, 11, 14, 15 and 17 to 21 in which it was confirmed in the procedure 1-3 described above that there is a version number difference transfer the new firmware.

Procedure 1-6: The monitoring processing section 17 monitors whether or not the transfer in the function sections 10, 11, 14, 15 and 17 to 21 is completed in a unit of the function blocks 8 and 9, and, if the transfer is completed, then a notification of completion of the transfer in a unit of the function blocks 8 and 9 is issued to the reset controlling section 14.

Procedure 1-7: The reset controlling section 14 carries out system resetting (overall resetting process) at a point of time at which the notification of transfer completion regarding all of the function blocks 8 and 9 is received from the monitoring processing section 17 (step S33).

Procedure 1-8: The function sections 10, 11, 14, 15 and 17 to 21 are started by the new firmware (steps S34-1, . . . , S34-n and S34) and the firmware updating process is completed. It is to be noted that, while, in the example illustrated in FIG. 7, all of the function sections 10, 11, 14, 15 and 17 to 21 are started by the new firmware, this is an example to the end, and actually the function sections 10, 11, 14, 15 and 17 to 21 in which it was confirmed in the procedure 1-3 described above that there is a difference of the version number are started by the new firmware.

In this manner, where the updating procedure #1 is selected, the function sections 10, 11, 14, 15 and 17 to 21 carry out the overall resetting process after the transfer process is completed. Therefore, the startup time period relating to the one communication scheme is sometimes influenced by the startup time period relating to the other communication scheme.

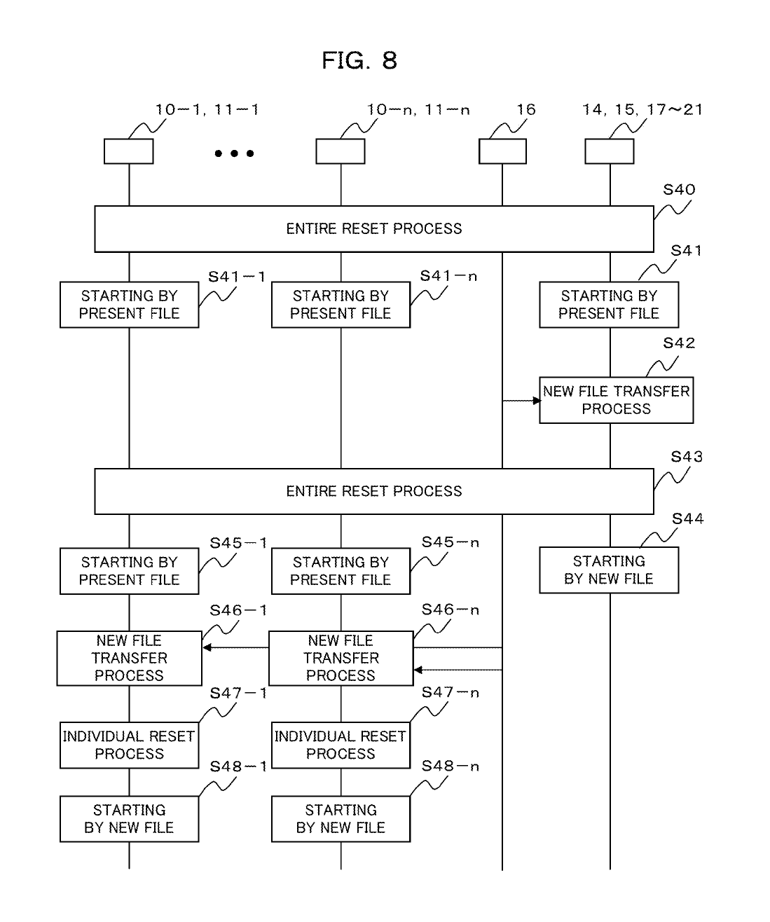

On the other hand, for example, as illustrated also in FIG. 8, the updating procedure #2 is carried out in accordance with procedures 2-1 to 2-12 described below.

Procedure 2-1: If a firmware updating opportunity by a reset command or the like from the network management apparatus 5 arises, then the reset controlling section 14 carries out system resetting (overall resetting process) (step S40).

Procedure 2-2: The function sections 10, 11, 14, and 17 to 21 are started by the present firmware (steps S41-1, . . . , S41-n and S41).

Procedure 2-3: The function sections 14, 15 and 17 to 21 in the common function block 9 confirm a difference between the version number of the firmware stored in the file storing memory 16 and the version number of the present firmware.

Procedure 2-4: If it is confirmed in the procedure 2-3 that there is a version number difference, then the function sections 14, 15 and 17 to 21 in the common function block 9 request transfer of the new firmware from the file storing memory 16 to the memories 22 to 28 in the function sections 14, 15 and 17 to 21 to the monitoring processing section 17.

Procedure 2-5: If the transfer request is received from the function sections 14, 15 and 17 to 21 in the common function block 9, then the monitoring processing section 17 starts transfer of the new firmware (step S42) and requests preparation for system resetting (overall resetting) to the reset controlling section 14.

Procedure 2-6: The monitoring processing section 17 monitors whether or not the transfer in the function sections 14, 15 and 17 to 21 in the common function block 9 is completed, and, if the transfer is completed, then a notification of completion of the transfer is issued to the reset controlling section 14.

Procedure 2-7: The reset controlling section carries out system resetting (overall resetting process) at a point of time at which the notification of transfer completion regarding all of the function sections 14, 15 and 17 to 21 is received from the monitoring processing section 17 (step S43).

Procedure 2-8: The function sections 14, 15 and 17 to 21 in the common function block 9 start by the new firmware (step S44), and the function sections 10 and 11 in each of the individual function blocks 8 start by the present firmware (steps S45-1, . . . and S45-n).

Procedure 2-9: The function sections 10 and 11 of each of the individual function blocks 8 confirm a difference between the version number of the firmware stored in the file storing memory 16 and the version number of the present firmware.

Procedure 2-10: If it is confirmed in the procedure 2-9 that there is a version number difference, then the function sections 10 and 11 in each individual function block 8 request transfer of the new firmware from the file storing memory 16 to the memories 12 and 13 in the function sections 10 and 11 to the monitoring processing section 17.

Procedure 2-11: If the transfer request is received from the function sections 10 and 11 in each individual function block 8, then the monitoring processing section 17 starts transfer of the new firmware (step S46-1, . . . and S46-n) and requests preparation for individual resetting of the individual function blocks 8 to the reset controlling section 14. It is to be noted that, while, in the example illustrated in FIG. 8, all of the function sections 10 and 11 transfer the new firmware, this is an example to the end, and actually the function sections 10 and 11 in which it was confirmed in the procedure 2-3 that there is a version number difference transfer the new firmware.

Procedure 2-12: The monitoring processing section 17 monitors whether or not transfer in the function sections 10 and 11 is completed in a unit of the individual function blocks 8, and if the transfer is completed, then a notification of transfer completion is issued to the reset controlling section 14 in a unit of the individual function blocks 8.

Procedure 2-13: The reset controlling section 14 carries out, at a point of time at which a notification of the transfer completion relating to an individual function block 8-i (i indicates a number from 1 to n) is received from the monitoring processing section 17, an individual resetting process for the individual function block 8-i (steps S47-1, . . . and S47-n).

Procedure 2-14: The function sections 10-i and 11-i in the individual function block 8-i are started by the new firmware (steps S48-1, . . . and S48-n), and the firmware updating process is completed. It is to be noted that, while, in the example illustrated in FIG. 8, all of the function sections 10 and 11 are started by the new firmware, this is an example to the end, and, actually the function sections 10 and 11 in which it is confirmed in the procedure 2-3 that there is aversion number difference are started by the new firmware.

In this manner, when the updating procedure #2 is selected, the function sections 10, 11, 14, 15 and 17 to 21 individually carry out the resetting process without waiting completion of the transfer process. Therefore, while startup time relating to one communication scheme is not influenced by startup time relating to the other communication scheme, the number of times of the overall resetting process is great in comparison with the updating procedure #1.

If the updating procedure #1 is selected, then a firmware update processing time period (T_total_i_method1) of the communication scheme corresponding to the individual function block 8-i is represented by the following expression (1):

[Expression 1]

T_total_{—}i_method1=max{(T_{—}ACT1+T_{—}DL1), . . . ,(T_ACTn+T_{—}DLn),(T_ACTcommon+T_{—}DLcommon)}+max{T_ACT1′, . . . ,T_ACTn′,T_ACTcommon′} (1)

where T_ACT1 to T_ACTn represent time periods required for starting of the individual function blocks 8-1 to 8-n, respectively, using the present firmware, and T_DL1 to T_DLn represent file transfer time periods of the new firmware in the individual function blocks 8-1 to 8-n, respectively.

Further, T_ACTcommon represents a time period required for starting of the common function block 9 using the present firmware, and T_DLcommon represents a file transfer time period of the new firmware in the common function block 9.

Further, T_ACT1′ to T_ACTn′ represent time periods required for starting of the individual function blocks 8-1 to 8-n, respectively, using the new firmware, and T_ACTcommon represents a time period required for starting of the common function block 9 using the new firmware.

It is to be noted that, where the updating procedure #1 is selected, the following expression (2) is satisfied:

[Expression 2]

T_total_{—}1_method1=T_total_{—}2_method1=T_total_{—}n_method1 (2)

On the other hand, if the updating procedure #2 is selected, then a firmware update processing time period (T_total_i_method2) of the communication scheme corresponding to the individual function block 8-i is represented by the following expression (3):

[Expression 3]

T_total_{—}i_method2=max{T_ACT1, . . . ,T_ACTn,(T_ACTcommon+T_{—}DLcommon)}+max{(T_ACTi+T_{—}DLi+T_ACTi′),T_ACTcommon′} (3)

where T_ACTi represents a time period required for starting of the individual function block 8-i using the present firmware, and T_DLi represents a file transfer time period of the new firmware in the individual function block 8-i.

Further, T_ACTi′ represents a time period required for starting of the individual function block 8-i using the new firmware.

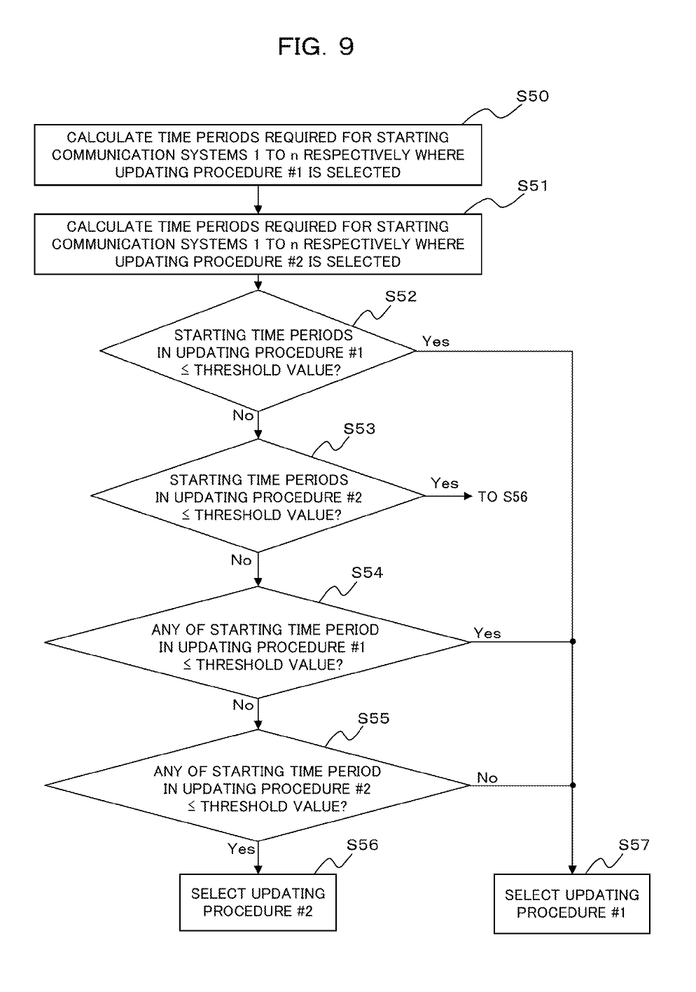

Here, a particular example of the process at step S22 is described with reference to FIG. 9.

As illustrated in FIG. 9, the update controlling section 19 first calculates (predicts) firmware update processing time periods represented by the expressions (1) to (3) regarding the communication schemes based on the time information acquired at steps S20 and S21 (steps S50 and S51). It is to be noted that the execution order of the processes at steps S50 and S51 does not matter.

Then, the update controlling section 19 decides whether or not the starting time period (T_total_i_method1) in the updating procedure #1 is equal to or shorter than the predetermined threshold value (for example, 10 minutes) (step S52), and if the T_total_i_method1 is equal to or shorter than the predetermined threshold value (Yes route at step S52), then the updating procedure #1 is selected (step S57).

If the starting time period starting time period T_total_i_method1 is not equal to or shorter than the predetermined threshold value (No route at step S52), then the update controlling section 19 decides whether or not the starting time period (T_total_i_method2) in the updating procedure #2 is equal to or shorter than the predetermined threshold value (step S53), and if the starting time period T_total_i_method2 is equal to or shorter than the predetermined threshold value (Yes route at step S53), then the updating procedure #2 is selected (step S56).

If the starting time period T_total_i_method2 is not equal to or shorter than the predetermined threshold value (No route at step S53), then the update controlling section 19 decides whether or not one of the starting time periods (T_total_i_method1) in the updating procedure #1 is equal to or shorter than the predetermined threshold value (step S54), and if one of the starting time periods T_total_i_method1 in the updating procedure #1 is equal to or shorter than the predetermined threshold value (Yes route at step S54), then the updating procedure #1 is selected (step S57).

On the other hand, if all of the starting time periods T_total_i_method1 are longer than the predetermined threshold value (No route at step S54), then the update controlling section 19 decides whether or not one of the starting time periods (T_total_i_method2) in the updating procedure #2 is equal to or shorter than the predetermined threshold value (step S55).

Then, if one of the starting time periods (T_total_i_method2s) in the updating procedure #2 is equal to or shorter than the predetermined threshold value (Yes route at step S55), then the update controlling section 19 selects the updating procedure #2 (step S56).

On the other hand, if all of the starting time periods T_total_i_method2 are longer than the predetermined threshold value (No route at step S55), then the update controlling section 19 selects the updating procedure #1 (step S57). It is to be noted that, if all of the starting time periods T_total_i_method2 are longer than the predetermined threshold value (No route at step S55), then the update controlling section 19 may increase the predetermined threshold value and repetitively carry out the processes at steps S52 to S55.

In particular, the update controlling section 19 functions as an example of a control section for selecting, from among a plurality of firmware updating procedures, a firmware updating procedure wherein a service stopping period, which arises from firmware updating in at least one of the individual function sections 8 and the common function section 9, in at least one of the communication schemes is equal to or shorter than the predetermined threshold value.

A notification of a result of the selection is issued from the update controlling section 19 to the monitoring processing section 17.

Referring back to FIG. 6, the monitoring processing section 17 decides whether or not a firmware updating opportunity (trigger) such as reception of the reset command arises (step S23), and, if a trigger does not arise (No route at step S23), then the monitoring processing section 17 waits as it is. On the other hand, if a trigger arises (Yes route at step S23), then the monitoring processing section 17 carries out the firmware updating process in accordance with the firmware updating procedure selected at step S22 by the update controlling section 19 (step S24).

In particular, the monitoring processing section 17 functions as an example of a processing section for carrying out the firmware updating procedure selected by the update controlling section 19.

Particularly, for example, where n=2, T_ACT1=2, T_ACT2=2, T_ACTcommon=2, T_DL1=6, T_DL2=1, T_DLcommon=2, T_ACT1′=2, T_ACT2′=2 and T_ACTcommon′=2 (the unit of all parameters is [min]):

T_total_{—}1_method1=T_total_{—}2_method1=max{(2+6),(2+1),(2+2)}+max{2,2,2}=10 [min] [Expression 4]

On the other hand, in similar conditions:

T_total_{—}1_method2=max{2,2,(2+2)}+max{(2+6+2),2}=14 [min] [Expression 5]

T_total_{—}2_method2=max{2,2,(2+2)}+max{(2+1+2),2}=9 [min] [Expression 6]

Here, for example, where the threshold value (Th) is 10 [min]:

T_total_{—}1method1≦Th

T_total_{—}2method1≦Th [Expression 7]

are both satisfied, and therefore, the update controlling section 19 selects the updating procedure #1.

As described above, with the present embodiment, the startup time period can be minimized and the service stopping time period can be reduced in the base station apparatus 3 that is capable of being ready for the plural communication schemes or in a like apparatus.

### [2] First Modification

The update controlling section 19 may select, from among a plurality of communication schemes, such a firmware updating procedure that the startup time period regarding a communication scheme whose priority is highest is shortest as in the example.

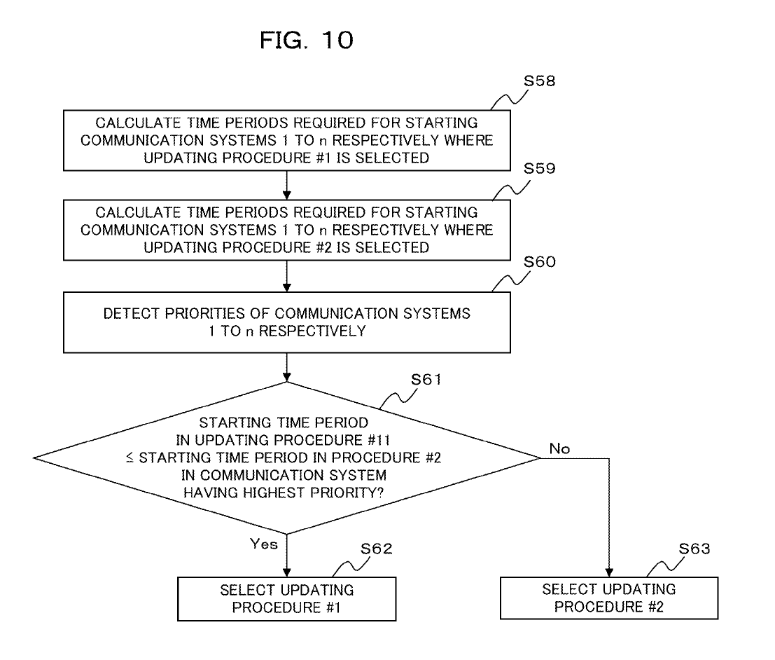

In this instance, at step S22 in FIG. 6, such processes as illustrated in FIG. 10 are carried out in place of the processes illustrated in FIG. 9.

As illustrated in FIG. 10, the update controlling section 19 first calculates (predicts) firmware update processing time periods represented by the expressions (1) and (3) given hereinabove regarding the communication schemes based on the time information acquired at steps S20 and S21 (steps S58 and S59). It is to be noted that the execution order of the processes at steps S58 and S59 does not matter.

Then, the update controlling section 19 detects the priority of each communication scheme (step S60). It is to be noted that the priority of each communication scheme may be retained in advance, for example, in the memory 26 in the update controlling section 19 or may be set from the outside such as the network management apparatus 5.

Then, the update controlling section 19 decides, regarding a communication scheme i whose priority is highest, whether or not the starting time period (T_total_i_method1) in the updating procedure #1 is equal to or shorter than the starting time period (T_total_i_method2) in the updating procedure #2 (step S61).

Here, if it is decided that the starting time period T_total_i_method1 is equal to or shorter than the starting time period T_total_i_method2 (Yes route at step S61), then the update controlling section 19 selects the updating procedure #1 (step S62).

On the other hand, if it is decided that the starting time period T_total_i_method1 is longer than the starting time period T_total_i_method2 (No route at step S61), then the update controlling section 19 selects the updating procedure #2 (step S63).

In particular, for example, where n=2, T_ACT1=2, T_ACT2=2, T_ACTcommon=2, T_DL1=6, T_DL2=1, T_DLcommon=2, T_ACT1′=2, T_ACT2′=2 and T_ACTcommon′=2 (the unit of all parameters is [min]):

T_total_{—}1_method1=T_total_{—}2method1=max{(2+6),(2+1),(2+2)}+max{2,2,2}=10 [min] [Expression 8]

On the other hand, in similar conditions:

T_total_{—}1method2=max{2,2,(2+2)}+max{(2+6+2),2}=14 [min] [Expression 9]

T_total_{—}2_method2=max{2,2,(2+2)}+max{(2+1+2),2}=9 [min] [Expression 10]

Here, for example, if the priority of the communication scheme A (i=1) is higher than the priority of the communication scheme B (i=2), then

T_total_{—}1_method1≦T_total_{—}1_method2 [Expression 11]

is satisfied, and therefore, the update controlling section 19 selects the updating procedure #1. On the other hand, for example, if the priority of the communication scheme B (i=2) is higher than the priority of the communication scheme A (i=1), then

T_total_{—}2method1≦T_total_{—}2_method2 [Expression 12]

is not satisfied, and therefore, the update controlling section 19 selects the updating procedure #2.

As described above, with the present modification, the startup time period of the function blocks regarding the communication scheme, whose priority is highest, from among the communication schemes can be minimized and the service stopping time period can be reduced.

### [3] Second Modification

Further, the update controlling section 19 may vary the priorities regarding the communication schemes in accordance with the time at present and select the firmware updating procedure in which the startup time period regarding the communication scheme whose priority is highest at each time is minimized as in the present modification.

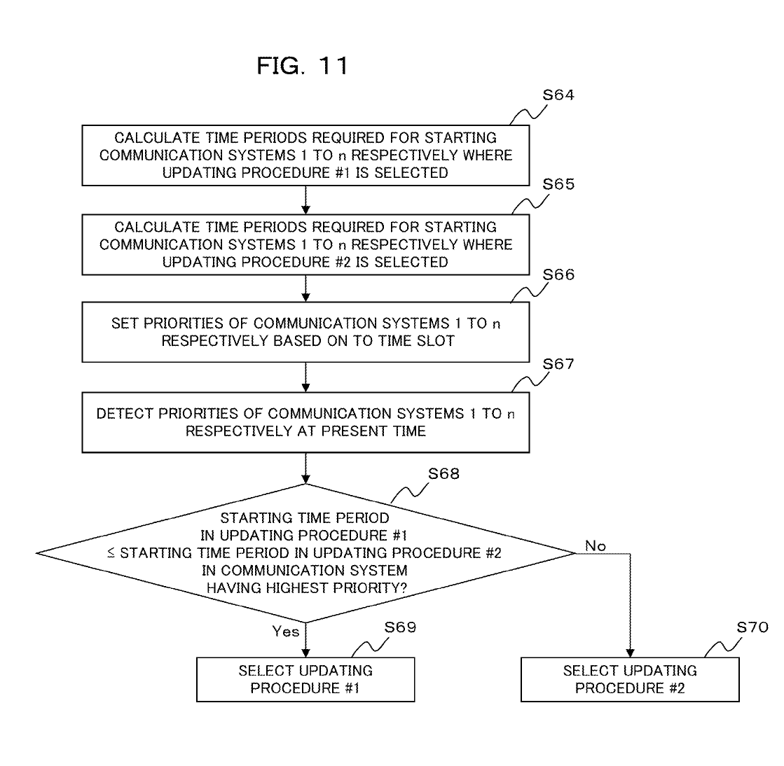

In this instance, such processes as illustrated in FIG. 11 are carried out at step S22 in FIG. 6 in place of the processes illustrated in FIG. 9.

As illustrated in FIG. 11, the update controlling section 19 first calculates (predicts) firmware update processing time periods represented by the expressions (1) and (3) given hereinabove regarding each communication scheme based on the time information acquired at steps S20 and S21 (steps S64 and S65). It is to be noted that the execution order of the processes at steps S64 and S65 does not matter.

Then, the update controlling section 19 sets priorities regarding each communication scheme in response to a time slot (step S66).

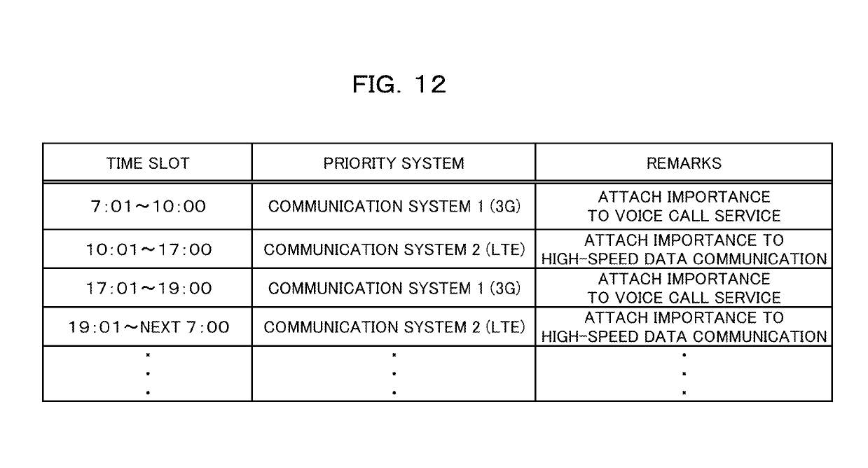

For example, as illustrated in FIG. 12, the update controlling section 19 can produce and store a table in which it is set what communication scheme is selected in priority in each time slot into the memory 26. It is to be noted that the substance of the table may be produced and updated, for example, by the network management apparatus 5 or the like.

In the example illustrated in FIG. 12, in a time slot from 7:01 to 10:00, the priority of 3G is set higher than the priority of LTE attaching importance to the voice calling service, but in a time slot from 10:01 to 17:00, the priority of the LTE method is set higher than the priority of the 3G method attaching importance to the high-speed data communication.

Further, in a time slot from 17:01 to 19:00, the priority of 3G is set higher than the priority of LTE attaching importance to the voice calling service, but in a time slot from 19:01 to 7:00 in the next day, the priority of LTE is set higher than the priority of 3G attaching importance to the high-speed data communication.

Then, the update controlling section 19 detects the priority of each communication scheme at the time at present based on the substance of the table described above (step S67).

The update controlling section 19 decides, regarding the communication scheme i whose priority is highest, whether or not the starting time period (T_total_i_method1) in the updating procedure #1 is equal to or shorter than the starting time period (T_total_i_method2) in the updating procedure #2 (step S68).

Here, if it is decided that the starting time period T_total_i_method1 is equal to or shorter than the starting time period T_total_i_method2 (Yes route at step S68), then the update controlling section 19 selects the updating procedure #1 (step S69).

On the other hand, if it is decided that the starting time period T_total_i_method1 is longer than the starting time period T_total_i_method2 (No route at step S68), then the update controlling section 19 selects the updating procedure #2 (step S70).

In particular, for example, where n=2, T_ACT1=2, T_ACT2=2, T_ACTcommon=2, T_DL1=6, T_DL2=1, T_DLcommon=2, T_ACT1′=2, T_ACT2′=2 and T_ACTcommon′=2 (the unit of all parameters is [min]):

T_total_{—}1_method1=T_total_{—}2_method1=max{(2+6),(2+1),(2+2)}+max{2,2,2}=10 [min] [Expression 13]

On the other hand, in similar conditions:

T_total_{—}1_method2=max{2,2,(2+2)}+max{(2+6+2),2}=14 [min] [Expression 14]

T_total_{—}2_method2=max{2,2,(2+2)}+max{(2+1+2),2}=9 [min] [Expression 15]

Here, for example, if the priority of the communication scheme A (i=1) at present time is higher than the priority of the communication scheme B (i=2) at present time, then

T_total_{—}1_method1≦T_total_{—}1_method2 [Expression 16]

is satisfied, and therefore, the update controlling section 19 selects the updating procedure #1.

On the other hand, for example, where the priority of the communication scheme B (i=2) at the time at present is higher than the priority of the communication scheme A (i=1) at the time at present,

T_total_{—}2_method1≦T_total_{—}2_method2 [Expression 17]

is not satisfied, and therefore, the update controlling section 19 selects the updating procedure #2.

As described above, with the present modification, the startup time period of the function blocks regarding the communication scheme, whose priority is highest in each time slot, from among the communication schemes can be minimized and the service stopping time period can be reduced.

### [4] Third Modification

Further, the update controlling section 19 may set the priorities based on calling accommodation ratios in the communication schemes and may select the firmware updating procedure in which the startup time period regarding the communication scheme whose priority is highest is minimized as in the present modification.

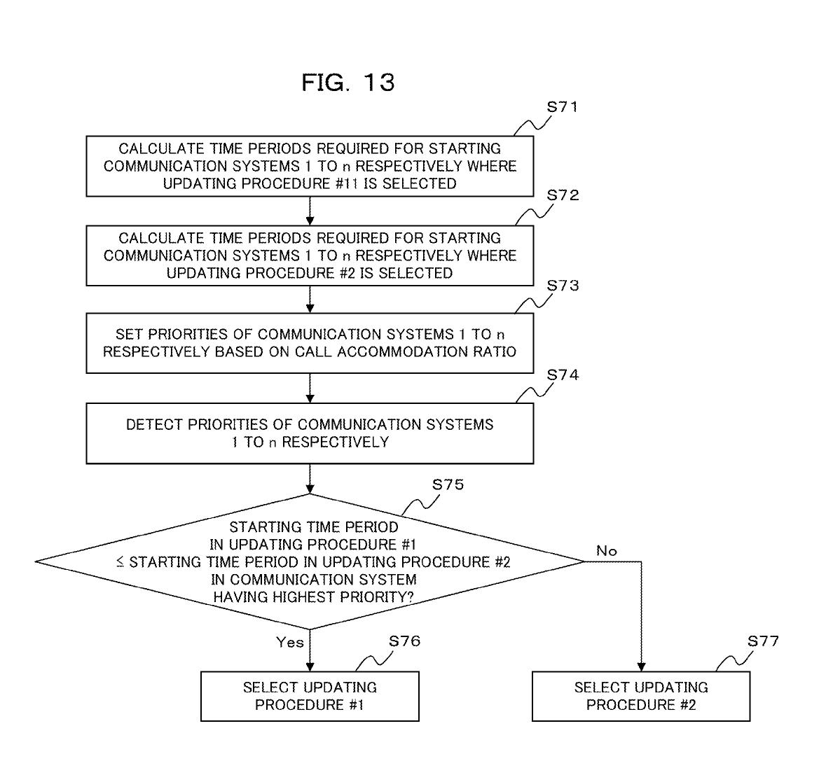

In this instance, such processes as illustrated in FIG. 13 are carried out at step S22 in FIG. 6 in place of the processes illustrated in FIG. 9.

As illustrated in FIG. 13, the update controlling section 19 first calculates (predicts) firmware update processing time periods represented by the expressions (1) and (3) given above regarding each communication scheme based on the time information acquired at steps S20 and S21 (steps S71 and S72). It is to be noted that the execution order of the processes at steps S71 and S72 does not matter.

Then, the update controlling section 19 calculates the call accommodation ratio in each communication scheme and sets the priorities regarding the communication schemes based on the calculated calling accommodation ratio (step S73).

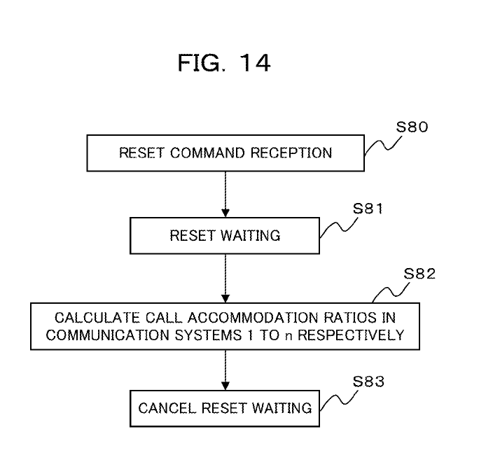

For example, as illustrated in FIG. 14, if the reset command that is a trigger of the firmware updating process is received from the network management apparatus 5 (step S80), then the update controlling section 19 waits the overall resetting process (step S81).

During the waiting, the update controlling section 19 calculates a ratio (call accommodation ratio) of the call number accommodated at preset with respect to the number of calls that can be accommodated in each communication scheme (step S82), and, if the calculation of the call accommodation ratios is completed, then the overall resetting process that has been waited till then is started (step S83). It is to be noted that the call accommodation ratios calculated at step S82 are desirably stored into a nonvolatile memory or the like in the base station apparatus 3.

Referring back to FIG. 13, the update controlling section 19 detects the priorities of the communication schemes set based on the call accommodation ratios (step S74).

Then, the update controlling section 19 decides, regarding the communication scheme i whose priority is highest, whether or not the starting time period (T_total_i_method1) in the updating procedure #1 is equal to or shorter than the starting time period (T_total_i_method2) in the updating procedure #2 (step S75).

Here, if it is decided that the starting time period T_total_i_method1 is equal to or shorter than the starting time period T_total_i_method2 (Yes route at step S75), then the update controlling section 19 selects the updating procedure #1 (step S76).

On the other hand, if it is decided that the starting time period T_total_i_method1 is longer than the starting time period T_total_i_method2 (No route at step S75), then the update controlling section 19 selects the updating procedure #2 (step S77).

In particular, for example, where n=2, T_ACT1=2, T_ACT2=2, T_ACTcommon=2, T_DL1=6, T_DL2=1, T_DLcommon=2, T_ACT1′=2, T_ACT2′=2 and T_ACTcommon′=2 (the unit of all parameters is [min]),

T_total_{—}1_method1=T_total_{—}2_method1=max{(2+6),(2+1),(2+2)}+max{2,2,2}=10 [min] [Expression 18]

On the other hand, in similar conditions:

T_total_{—}1_method2=max{2,2,(2+2)}+max{(2+6+2),2}=14 [min] [Expression 19]

T_total_{—}2_method2=max{2,2,(2+2)}+max{(2+1+2),2}=9 [min] [Expression 20]

Here, for example, if the set call number (accommodated call number) in the communication scheme A (i=1) is 50 and the maximum accommodation number of calls in the communication scheme A is 100, then it is calculated that the call accommodation ratio of the communication scheme A is 50%.

Further, for example, if the set call number (accommodated call number) in the communication scheme B (i=2) is 30 and the maximum accommodation number of calls in the communication scheme B is 100, then it is calculated that the call accommodation ratio of the communication scheme B is 30%.

At this time, since the call accommodation ratio of the communication scheme A is higher than the call accommodation ratio of the communication scheme B, the update controlling section 19 sets the priority of the communication scheme A higher than the priority of the communication scheme B. Further, since, regarding the communication scheme A,

T_total_{—}1_method1≦T_total_{—}1_method2 [Expression 21]

is satisfied, the update controlling section 19 selects the update method 1.

As described above, with the present modification, the startup time period of the function blocks regarding the communication scheme, whose call accommodation ratio is highest, from among the communication schemes can be minimized and the service stopping time period can be reduced. Therefore, the influence to be had on the user upon firmware updating can be minimized.

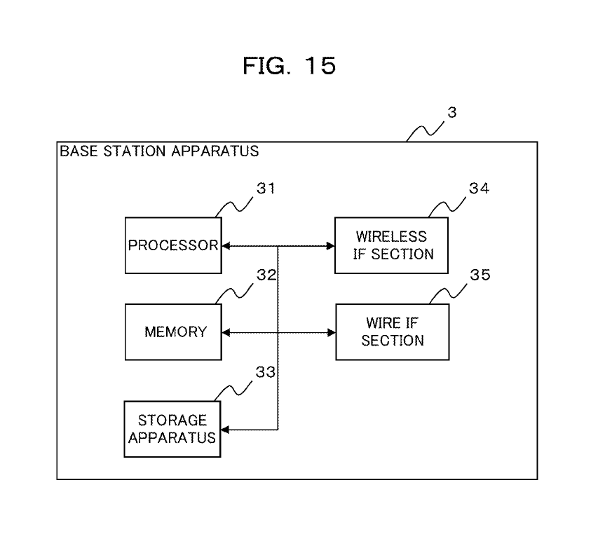

### [4] Example of the Hardware Configuration Here, an example of a hardware configuration of the base station apparatus 3 is illustrated in FIG. 15.

As illustrated in FIG. 15, the base station apparatus 3 illustratively includes a processor 31, a memory 32, a storage apparatus 33, a wireless interface (wireless IF) section 34 and a wire interface (wire IF) section 35.

The processor 31 is an apparatus that processes data and includes, for example, a CPU (Central Processing Unit), a DSP (Digital Signal Processor), an LSI (Large Scale Integration), an FPGA (Field-Programmable Gate Array) and so forth. The memory 32 and the storage apparatus 33 store data and include, for example, a ROM (Read Only Memory), a RAM (Random Access Memory), a magnetic storage apparatus and so forth. The wireless IF section 34 is an interface apparatus for carrying out wireless communication with the UE 2. The wire IF section 35 is an interface apparatus for carrying out wire communication with a different wireless base station, upper apparatuses 4-1 to 4-n, a network management apparatus 5 and so forth connected to a network (backhaul network) on the network side of the portable telephone system.

It is to be noted that the corresponding relationship between the components of the base station apparatus 3 illustrated in FIG. 4 and the components of the base station apparatus 3 illustrated in FIG. 15 is, for example, such as given below.

The processor 31 and the memory 32 correspond, for example, to the function sections 10, 11, 14, 15 and 17 to 20. The memory 32 and the storage apparatus 33 correspond, for example, to the memories 12, 13 and 22 to 28. The processor 31, memory 32 and wireless IF section 34 correspond, for example, to the RE 6, and the processor 31, memory 32 and wire IF section 35 correspond, for example, to the network side transmission and reception processing section 21.

### [5] Others

It is to be noted that the components and the functions of the base station apparatus 3 in the embodiment and the modifications described above may be suitably chosen or used in combination as occasion demands. In particular, the components and the functions described above may be chosen or suitably combined and used so that the functions of the present invention can be demonstrated.

For example, which one of the firmware update controlling methods in the embodiment and the modifications described above is to be used may be suitably changed over by designating outside information (for example, station data and so forth), for example, by the network management apparatus 5.

It is to be noted that the functions of the base station apparatus 3 described above may be implemented by a computer (including a CPU, an information processing apparatus, and various terminals) executing a predetermined program (signal processing program).

The signal processing program can be provided in the form in which it is recorded on a computer-readable recording medium such as, for example, a flexible disk, a CD (CD-ROM, DC-R, CD-RW and so forth), or a DVD (DVD-ROM, DVD-RAM, DVD-R, DVD-RW, DVD+R, DVD+RW and so forth). In this instance, the computer can read the signal processing program from the recording medium, transfer and store the signal processing program to and into an internal storage apparatus or an external storage apparatus and then use the signal processing program. Or, the signal processing program may be recorded into a recording apparatus (recording medium) such as, for example, a magnetic disk, an optical disk or a magneto-optical disk such that it may be provided from the storage apparatus to the computer through a communication line. It is to be noted that, in addition to a flexible disk, a CD, a DVD, a magnetic disk, an optical disk and a magneto-optical disk mentioned hereinabove, an IC card, a ROM cartridge, a magnetic tape, a punched card, an internal storage apparatus (memory such as a RAM or a ROM) of a computer, an eternal storage apparatus, and a printed matter on which codes such as bar codes are printed can be utilized as the recording medium.

Further, the computer conceptually includes hardware and an OS (Operating System) and signifies the hardware that operates under the control of the OS. Further, in such a case that the OS is not required and the hardware is operated solely by the program, the hardware itself corresponds to the computer. The hardware at least includes a processor such as a CPU, and means for reading the computer program recorded on the recording medium.

Further, a program as the signal processing program described above includes program codes for implementing the functions of the base station apparatus 3. Further, some of the functions may be implemented by the OS.

According to an aspect of the embodiments, the service stopping period involved in updating of firmware can be reduced.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment (s) of the present invention have been described in detail, it should be understood that the various changes, substitutions, and alterations could be made hereto without departing from the spirit and scope of the invention.

What is claimed is:

1. An update controlling method for firmware in a communication apparatus including a plurality of individual function sections that function uniquely to a plurality of communication schemes respectively and a common function section that functions commonly to the communication schemes, comprising:
selecting, from among a plurality of firmware updating procedures, a firmware updating procedure by which a service stopping period that arises, in at least one of the communication schemes, from firmware updating in at least one of the common function section and the individual function sections, the service stopping period being equal to or lower than a predetermined threshold value; and
carrying out the selected firmware updating procedure.

2. The update controlling method for firmware according to claim 1, wherein the firmware updating procedures include:
a first firmware updating procedure for re-starting the individual function sections and the common function section all together after new firmware is transferred to at least one of the common function section and the individual function sections whose firmware is to be updated, thereby starting the individual function sections and the common function section using the new firmware; and
a second firmware updating procedure for re-starting, after the new firmware is transferred to the common function section whose firmware is to be updated, the individual function sections and the common function section all together, thereby starting the common function section using the new firmware and then individually re-starting the individual function sections to which the new firmware has been transferred from among at least one of the individual function sections whose firmware is to be updated, thereby individually starting the individual function sections using the new firmware.

3. The update controlling method for firmware according to claim 1, wherein the service stopping period is calculated based on a period of time required for starting the individual function sections and the common function section whose firmware is to be updated using old firmware before the firmware updating, a period of time required for transferring new firmware to the individual function sections and the common function section in the communication apparatus and a period of time required for starting the individual function sections and the common function section using the new firmware.

4. The update controlling method for firmware according to claim 1, wherein a firmware updating procedure by which the service stopping period in a communication scheme that has the highest priority is shortest is selected from among the firmware updating procedures.

5. The update controlling method for firmware according to claim 4, wherein the priority is set based on a time slot; and
a firmware updating procedure by which the service stopping period in a communication scheme that has the highest priority at the present point of time is shortest is selected from among the firmware updating procedures.

6. The update controlling method for firmware according to claim 4, wherein the priority is set based on an accommodation rate of each call in the communication schemes; and
a firmware updating procedure by which the service stopping period in a communication scheme that has the highest priority upon the firmware updating is shortest is selected from among the firmware updating procedures.

7. An updating controlling apparatus for firmware in a communication apparatus including a plurality of individual function sections that function uniquely to a plurality of communication schemes respectively and a common function section that functions commonly to the communication schemes, comprising:
a controller that selects, from among a plurality of firmware updating procedures, a firmware updating procedure by which a service stopping period that arises, in at least one of the communication schemes, from firmware updating in at least one of the common function section and the individual function sections, the service stopping period being equal to or lower than a predetermined threshold value; and
a processing section that carries out the firmware updating procedure selected by the controller.

8. A base station apparatus that includes a plurality of individual function sections that function uniquely to a plurality of communication schemes respectively and a common function section that functions commonly to the communication schemes, comprising:
a controller that selects, from among a plurality of firmware updating procedures, a firmware updating procedure by which a service stopping period that arises, in at least one of the communication schemes, from firmware updating in at least one of the common function section and the individual function sections, the service stopping period being equal to or lower than a predetermined threshold value; and
a processing section that carries out the firmware updating procedure selected by the controller.

9. A communication system, comprising:
a base station apparatus according to claim 8; and
a user apparatus capable of communicating with the base station apparatus.

10. A computer-readable recording medium having stored therein a program for causing a computer to update firmware in a communication apparatus that includes a plurality of individual function sections that function uniquely to a plurality of communication schemes and a common function section that functions commonly to the communication schemes, the program causing the computer to execute a process comprising:
selecting, from among a plurality of firmware updating procedures, a firmware updating procedure by which a service stopping period that arises, in at least one of the communication schemes, from firmware updating in at least one of the common function section and the individual function sections, the service stopping period being equal to or lower than a predetermined threshold value; and
carrying out the selected firmware updating procedure.
